(19) United States
(12) Patent Application Publication
(10) Pub. No.: US 2016/0357715 A1
(43) Pub. Date: Dec. 8, 2016

(54) MECHANISMS TO SUPPORT MULTI-SERVICE HYPERLINK PIPELINES IN WEB BROWSER

(71) Applicant: Futurewei Technologies, Inc., Plano, TX (US)

(72) Inventors: Li LI, Bridgewater, NJ (US); Wu CHOU, Basking Ridge, CA (US); Tao CAI, Shenzhen (CN)

(21) Appl. No.: 14/729,755

(22) Filed: Jun. 3, 2015

(51) Int. Cl. G06F 17/22; G06F 3/0484; G06F 17/24; H04L 29/08

(52) U.S. Cl. CPC G06F 17/2235; H04L 67/02; G06F 17/2247; G06F 3/04842; G06F 17/241

(57) ABSTRACT

A multi-service hyperlink pipeline model and system is proposed herein that allows a website to associate and present a plurality of service templates and custom JavaScript functions with a single resource in HTML documents and users to combine a service template with hyperlinks to form hyperlink pipelines and execute a hyperlink pipeline to automatically invoke the custom JavaScript functions.

### BACKGROUND

The World Wide Web (more commonly known as the “Web”) is a distributed information space, in which each piece of information is a part of a system of interlinked hypertext documents that are accessed via the Internet. A web browser (commonly referred to as a browser) is a software application for retrieving, presenting, and traversing information resources (such as a web page, image, video or other piece of content) on the Web. An information resource is identified by a corresponding string of characters called its Uniform Resource Identifier/Locator (URI/URL). Pre-defined “hyperlinks” (traversible references) present in these information resources enable users to navigate web browsers to other related resources, and allow web users to retrieve, create, delete or update information stored in various web servers.

However, users can typically only create new information by entering data in forms, which are usually pre-defined. While this methodology facilitates access to well structured information and applications, users are typically not able to compose web services in new and/or customized ways that are not already specifically pre-determined and provided by the website's developer. Without allowing user customization via user-selected service composition, web services run the risk of either not satisfying user needs when only a relatively few functions are provided, or becoming too complicated by trying to satisfy the needs of all users when a large number of functions are pre-determined and provided. Moreover, web services designed in this manner are often incapable of interoperating with other web services with each other except in a very limited manner, i.e., following the predefined hyperlinks and forms.

Various solutions have been proposed and commercialized to increase the versatility of web browsers. Some solutions allow users to combine existing Web data and functions into new information. However, each of the available solutions suffer from substantial drawbacks. These may include, for example, requiring additional software installation (e.g., browser plug-ins), requiring special hardware (composition servers), or using complex service description languages that are unsuitable for most regular users.

### SUMMARY

As a solution to the problems noted above, a novel hyperlink pipeline model is proposed herein that allows a user to create composite web services by chaining atomic information resources into a pipeline. According to an aspect of the claimed subject matter, a user can chain desired hyperlinks into a new composite hyperlink that identifies and describes the composite service, which can be used in subsequent hyperlinks recursively.

According to these embodiments, tasks can be achieved quickly by such a hyperlink pipeline system. For example, a user can chain a hyperlink to photographs hosted online with another hyperlink to a map to display the photographs in corresponding locations on the map. In one or more embodiments, such hyperlink pipelines are automatically reusable when the reference resources change without breaking the service interfaces, and through modifications.

According to an aspect of the claimed subject matter a functional composition framework is provided to tie hyperlink pipelines with REST (Representational State Transfer) web services by combining semantic web technologies (e.g., Microdata) with REST design principles. An object-oriented mechanism is further provided in one or more embodiments to implement the interactive hyperlink pipeline composition in web browsers without any plug-ins.

According to embodiments of the present invention, a single resource is able to be associated with a plurality of service templates and each template can have a plurality of parameters using a special markup language Microdata+, such that a service template can be instantiated many times to form hyperlink pipeline instances in HTML documents. Embodiments of the present invention also allow a service template to contain a custom JavaScript function and a hyperlink pipeline to invoke these custom JavaScript function automatically when it is executed.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a graphical depiction of an exemplary tree representation of a hyperlink pipeline, in accordance with embodiments of the present invention.

FIG. 2 depicts a block diagram of an exemplary server-based composition framework, in accordance with embodiments of the present invention.

FIG. 3 depicts a block diagram of an exemplary client-based composition framework, in accordance with embodiments of the present invention.

FIG. 4 depicts a UML class diagram of a pipeline factory, in accordance with embodiments of the present invention.

FIG. 5 depicts a diagram of a factory module, in accordance with embodiments of the present invention.

FIG. 6 depicts a diagram of possible execution flows of a hyperlink pipeline, in accordance with embodiments of the present invention.

FIG. 7 depicts a diagram of several exemplary multi-service resources associated with one or more services which can form hyperlink pipelines, in accordance with embodiments of the present invention.

FIG. 8 depicts a diagram of a system architecture for constructing multi-service hyperlink pipelines, in accordance with embodiments of the present invention.

FIG. 9 depicts a UML class diagram of resources in a multi-service pipeline system, in accordance with one or more embodiments of the present invention.

FIG. 10 depicts a state diagram of exemplary states for a service in a multi-service pipeline system, in accordance with embodiments of the present invention.

FIG. 11a depicts an exemplary HTML document containing special markup language, in accordance with embodiments of the present invention.

FIG. 11b depicts a data structure of the accept-call function parsed from the specification in an exemplary HTML document, in accordance with embodiments of the present invention.

FIG. 12 depicts an exemplary generic process to evaluate any custom JavaScript functions associated with a service function during the execution of a hyperlink pipeline, in accordance with embodiments of the present invention.

FIG. 13 depicts an exemplary flowchart for a method for constructing a hyperlink pipeline using a service template associated with a multi-service resource, in accordance with embodiments of the present invention.

FIG. 14 depicts an exemplary computing environment, in accordance with embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known processes, procedures, components, and circuits have not been described in detail as not to unnecessarily obscure aspects and features of the subject matter.

Portions of the detailed description that follow are presented and discussed in terms of a process. Although steps and sequencing thereof are disclosed in figures herein describing the operations of this process, such steps and sequencing are exemplary. Embodiments are well suited to performing various other steps or variations of the steps recited in the flowchart of the figure herein, that not all of the steps depicted may be performed, or that the steps may be performed in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The claimed subject matter is directed to a method and system for supporting multi-service hyperlink pipelines in web browsers that include customized hyperlink presentations and JavaScript functions. In particular, an architecture that provides customizable, multi-service, and multi-parameter hyperlink pipelines is described herein.

### Composition Framework

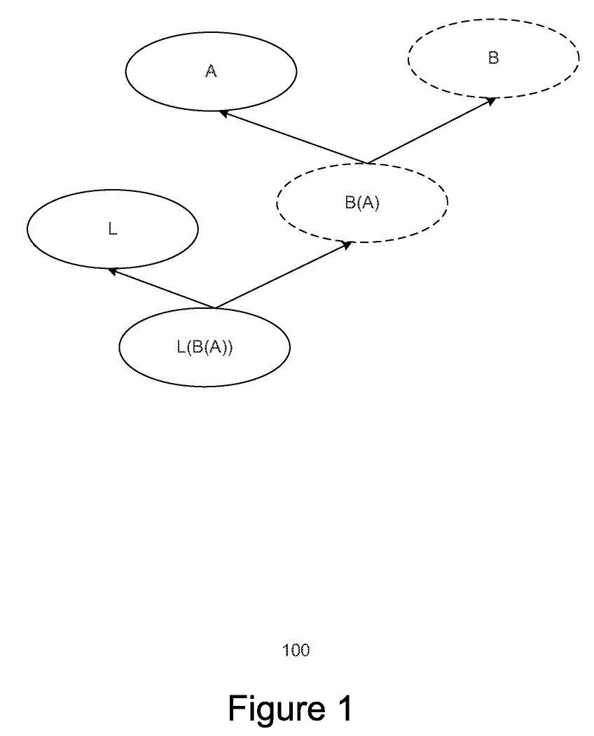

In a Representational State Transfer (REST) based hyperlink pipeline system, each hyperlink denotes a function (resource) that maps some incoming representation to some outgoing representation when the hyperlink is de-referenced. For example, a destination hyperlink D can accept a source hyperlink S to create a hyperlink pipeline P, denoted by function D(S), if and only if the outgoing representation of S matches the incoming representation of D. This functional framework can represent arbitrary recursive hyperlink compositions in pure URI syntax. FIG. 1 depicts a tree representation 100 of a hyperlink pipeline. Dashed circles in FIG. 1 depict sources. As depicted in FIG. 1, hyperlink C accepts hyperlink A to create pipeline C(A), then hyperlink C(A) accepts hyperlink B to create pipeline C(A)(B). Finally, hyperlink D accepts hyperlink C(A)(B) to create pipeline D(C(A)(B)).

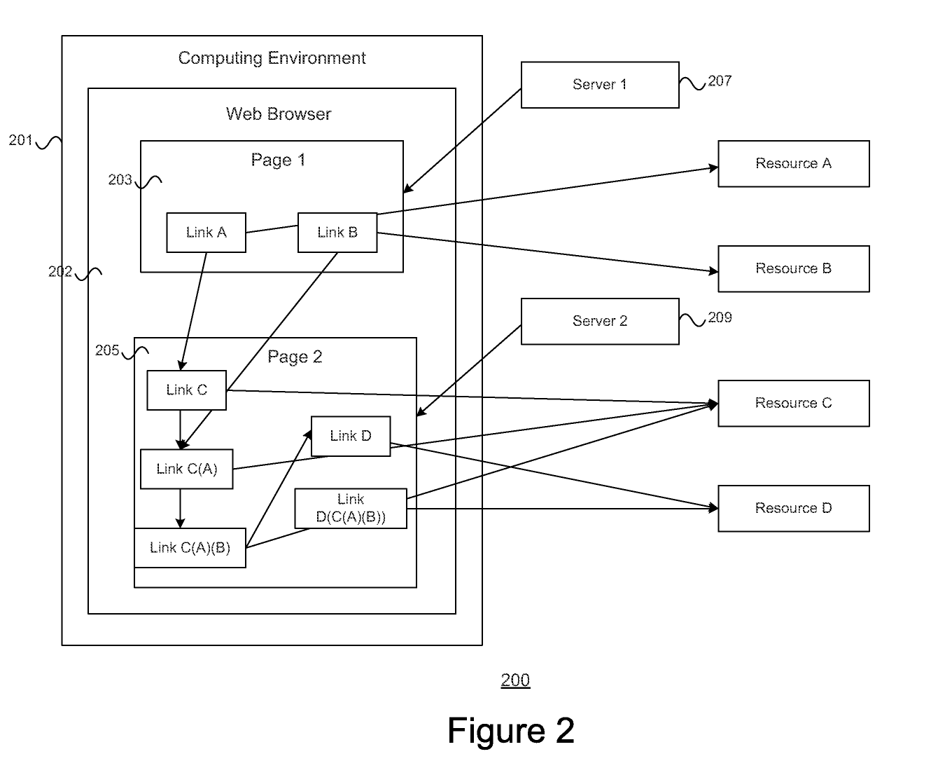

The functional composition framework also provides a distributed method to execute hyperlink pipelines, as illustrated in FIG. 2. As depicted in FIG. 2, the composition framework may be executed in the web browser (202) of a computing environment (201). In one or more embodiments, the web browser (202) may be executed by a processor of the computing environment (201) and used to display one or more web pages (e.g., first web page 203 and a second web page 205). Each of the one or more web pages may display content supplied from one or more servers (e.g., Server 1 (207) and Server 2 (209)). In one or more embodiments, the content may be presented as hyperlinks (e.g., Links A, B, C, D) that represent web resources (Resources A 211, B 213, C 215, and D 217, respectively) Customized hyperlink pipelines (e.g., Link C(A)(B) and Link D(C(A)(B)) can be created through a user selection (via a web browser 201) of Links A, B, C, and D in web page 1 (203) and web page 2 (205). When the hyperlink pipeline D(C(A)(B)) is selected (e.g., as a signal via a user input device), the web browser de-references the corresponding URI of the hyperlink pipeline by contacting resource D and providing the argument C(A)(B). Next, resource D de-references its argument by contacting resource C, providing as arguments resources A and B. Finally, resource C dereferences the URIs of resources A and B accordingly. After all the URIs are de-referenced, the resources can exchange necessary messages to finish the service composition in a server, with the final result being transmitted back to the browser.

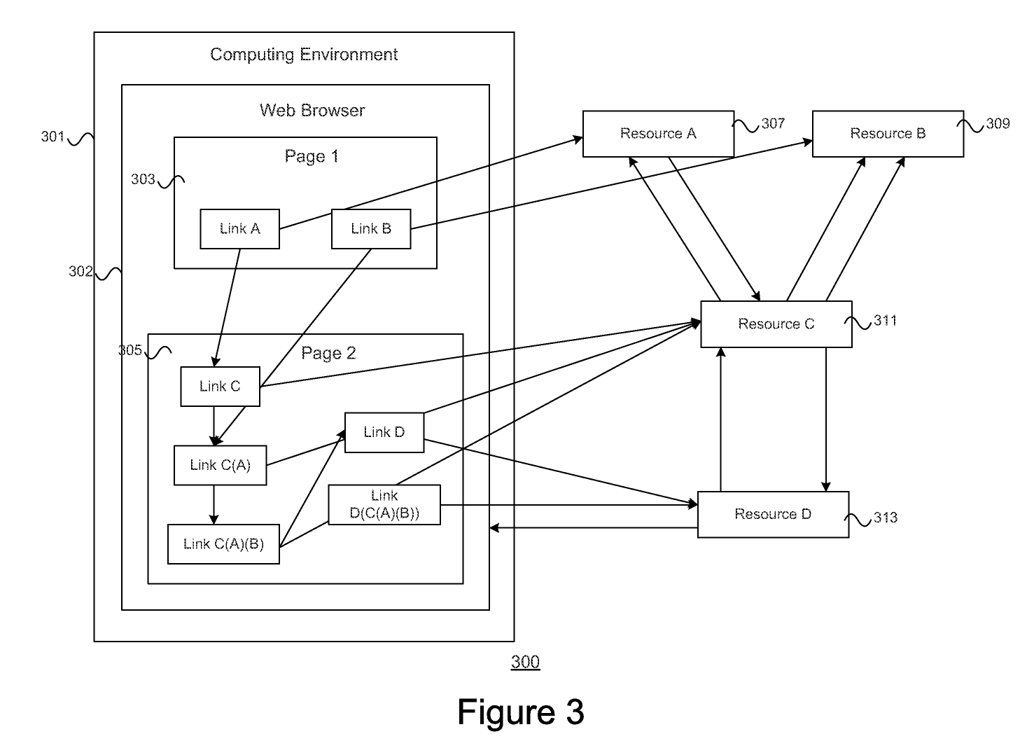

FIG. 3 depicts an alternate embodiment wherein the pipeline is implemented by the web browser (302) executing in a client computing environment (301), in contrast to server-based execution depicted in FIG. 2. As depicted in FIG. 3, a web browser (302) viewing one or more web pages (303, 305), each depicting one or more URL hyperlinks (Links A, B, C, D) of content corresponding to web resources (Resources A 307, B,309, C 311, and D 313). Whereas the execution of hyperlink pipelines in FIG. 2 is performed via servers (207, 209), hyperlink pipelines may instead be executed in client (e.g., through the web browser 302) according to alternate embodiments of the claimed subject matter.

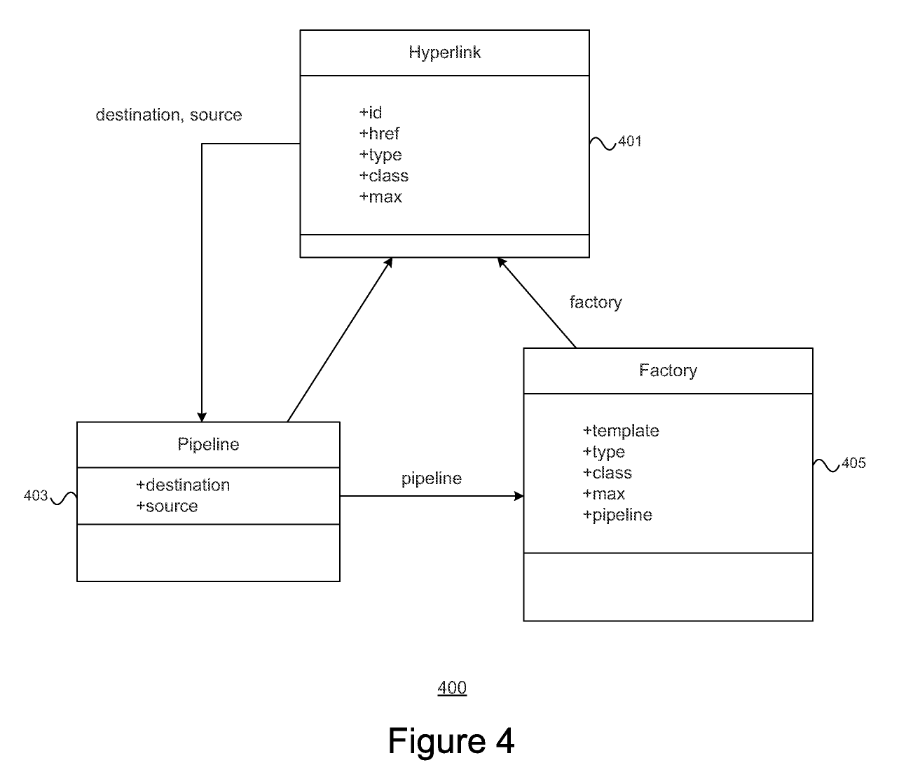

According to such a framework, a hyperlink also needs to be able to verify the other hyperlink as a valid argument based on the service description of the hyperlinks. For this reason, a novel solution that provides client-side service description based on Microdata is described, such that the descriptions are embedded inside HTML pages and all the tests are carried out within a web browser without any network traffic. According to one or more embodiments, the client-side service description and test mechanism is configured to: 1) indicate where and what pipelines can be formed from which hyperlinks on a HTML page, (since not all hyperlinks can form valid hyperlink pipelines); and 2) allow web applications to customize hyperlink pipeline presentation, execution and management without sacrificing interoperability between hyperlink pipelines. To achieve these goals, a HTML5 Microdata language is described herein to annotate hyperlinks with a “pipeline factory” according to the UML class diagram in FIG. 4.

As depicted in FIG. 4, instances of a pipeline class (401) includes a destination property and a source property. In one or more embodiments, each of the destination and the source property refers to an instance of a hyperlink class (403), that includes, for example, properties such as “id” (identity), “href” (hyperlink reference), “type” (resource type), “class” (resource class), and “max” (maximum number of accepted sources). According to further embodiments of the claimed subject matter, each destination hyperlink uses an instance of the factory class (405) to check source hyperlinks and produce hyperlink pipelines. According to further embodiments, the hyperlink pipelines produced from the same destination hyperlink will inherit the factory, type, and class properties of the destination, but may have other properties rewritten for a customized user experience.

According to one or more embodiments, a Microdata pipeline factory may be implemented to consist of one or more of the following properties:

a template property;

a type property;

a class property;

a max property; and

a pipeline property.

The template property may be implemented as, for example, implemented as, for example, a URI template with a destination variable {dest} that can be replaced by the destination URI and a source variable {src} that can be replaced by the source URI when the pipeline is composed. The type property may be implemented as a list of accepted media types for the outgoing representations of the sources. The class property may, according to various embodiments, be implemented as a list of accepted semantic classes for the outgoing representations of the sources. The max property may be implemented as the maximum number of accepted sources, with the default being set equal to 1, and if unbounded, set equal to −1, for example. The pipeline property itself may be implemented as a URI pointing to a HTML5 DOM (document object model) element which stores the pipeline element as a child element. The DOM element may also contain a special element which defines the pipeline template for the pipeline elements in it. In one embodiment, the default pipeline template is the HTML5<a> element.

The template property allows an application to customize the URI representation of functions if it does not want to use the default parentheses characters reserved by standard URI syntax. The pipeline property allows applications to use JavaScript and Cascading Style Sheets (CSS) to customize the presentation and execution of the created pipelines for consistent look-and feel. For example, an application can use a pipeline template to display the pipeline as an image and invoke some JavaScript code when the pipeline is clicked. An pipeline template may be expressed as, for example:

<a onclick=”execute( )” id=”template”>
<img src=”pipe.png”>...</img>
</a>

A factory annotation can be attached to the HTML code for hyperlink B in FIG. 1, for example. After hyperlink B accepts hyperlink A (via user input), hyperlink pipeline B(A) is created as an HTML5<a> element with properties represented in Microdata.

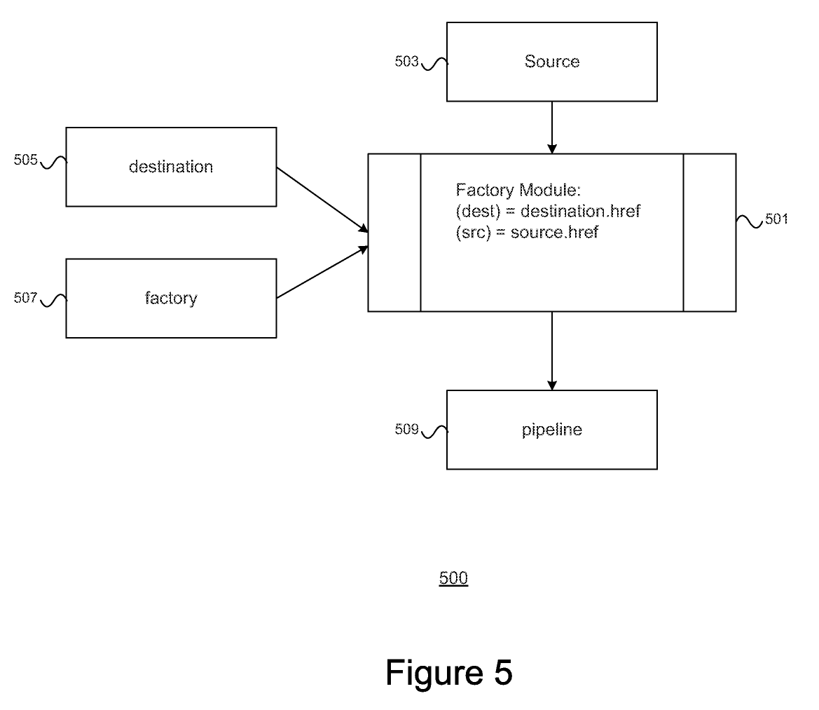

According to one or more embodiments, hyperlink pipelines may be constructed interactively. Each hyperlink that can create a hyperlink pipeline can be annotated with Microdata. A generic constructor, called Factory Module, can be used to construct the hyperlink pipelines as illustrated below (FIG. 5).

FIG. 5 depicts an exemplary construction procedure that includes a source 503, a destination 505, a factory 507 being combined by a factory module 501 to construct a hyperlink 509. The construction procedure may be expressed as:

Construct (D: destination, F: factory, S: source, P: pipeline):

1. If D.max>0, continue; otherwise stop;

2. If S.type is subtype of F.type according to Internet Media Type, continue; otherwise stop;

3. If S.class is subclass of F.class according to rdfs:subClassOf defined by RDFS, continue; otherwise stop;

4. Create a DOM element P under F.pipeline element according to its template;

5. Set P.href=F.template where {dest}=D.href and {src}=S.href,

6. P.type=D.type, P.class=D.class, P.max=D.max−1, P.destination=D, P.source=S;

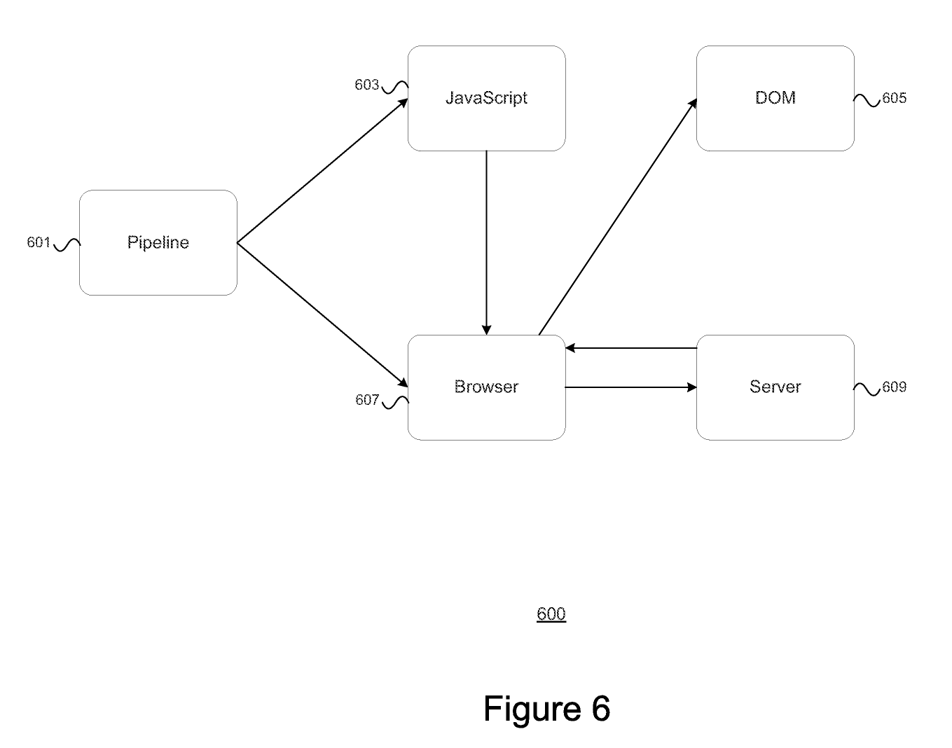

Within the general execution plan in FIG. 5, hyperlink pipelines can be executed in two ways as illustrated in FIG. 6: by the 1) by the hyperlink dereference mechanism in web browser; and 2) by custom JavaScript in web page. For example, to execute the pipeline 601 in FIG. 6, a pipeline can be de-referenced in a web browser 607, which requests from the server 609 content (web resources). The pipeline itself may be executed in the server 609. Alternatively, the browser 607 can invoke a WebRTC JavaScript API and a Websocket JavaScript API (JavaScript 603). To execute a hyperlink pipeline with a map website for example, the page can call the map website's JavaScript API.

According to further embodiments, hyperlink pipeline states are also represented in the described framework. Hyperlink pipelines may have distinct corresponding states. For example, a hyperlink pipeline may be created in an “initial” state, and later transition to some intermediate state, e.g., “pending” or “in progress” when actuated/activated, then to a final “success” or “failure” state based on backend service executions. Alternatively, hyperlink pipelines may have only one state, depending on the service/action. For example, to attach some images to a graphical map, the images should appear on the graphical map immediately. In this case, the created hyperlink pipeline map may only have a final state (e.g., graphical map with images).

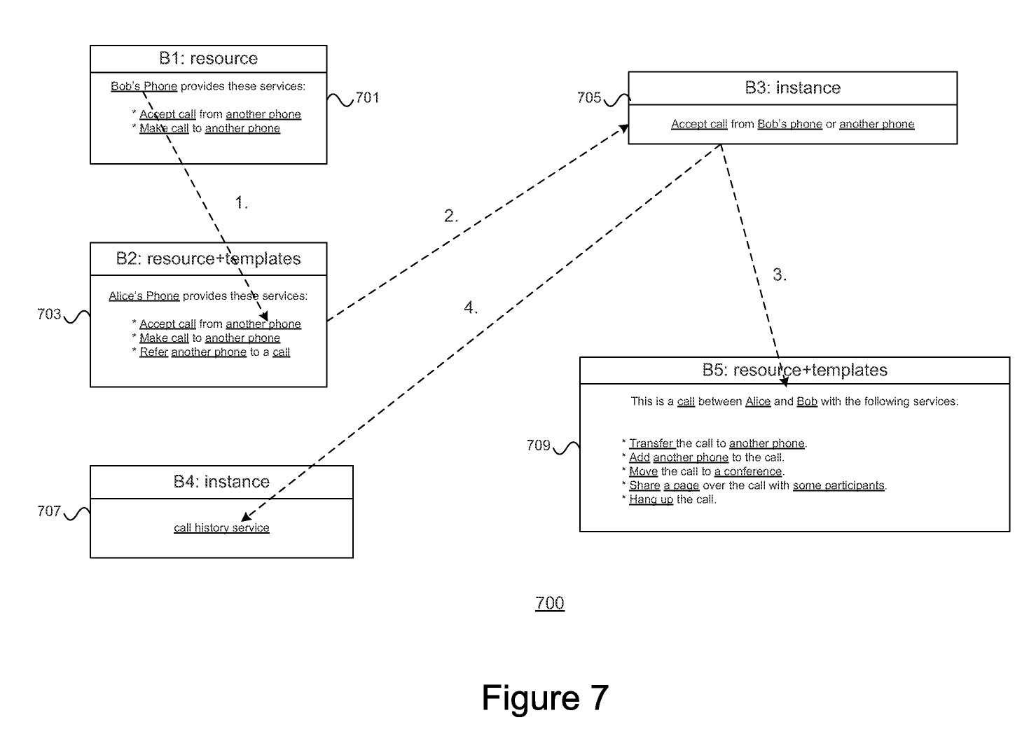

In one or more embodiments, a hyperlink pipeline may be created from a service associated with a resource. FIG. 7 depicts a diagram 700 of several exemplary multi-service resources associated with one or more services which can form hyperlink pipelines, in accordance with embodiments of the present invention. As depicted in FIG. 7, a first resource 701 (‘Bob’s Phone”) may provide one or more services (functions), e.g., “accept call” or “make call.” Each service generates a video or voice call with another resource (of a type “phone”, for instance). In an exemplary process, the first resource 701 may be associated—by a user action, for example—using the “accept call” service of the second resource 703 (which may be displayed on the same or a different web page as the resource 701) to form a hyperlink pipeline instance displayed in 705. The hyperlink pipeline instance 705 can be again associated with a service of a third resource 707, or executed to produce a forth resource 709.

In one or more embodiments, an instance (705) of the hyperlink pipeline can be created and/or activated by dragging (in a web browser) a graphical representation of the source hyperlink in 701 in proximity to a graphical representation of the destination hyperlink in 703. As depicted in FIG. 7, executing a hyperlink pipeline initiates a call between two remote web browsers operated by the corresponding users, and a second user (corresponding to the second web resource) is able to accept the call via a second instance of a web browser executing in a second computing device. When the call is accepted, the instance of the hyperlink pipeline transitions to a ready state and the two users can converse using the service instance according to the application.

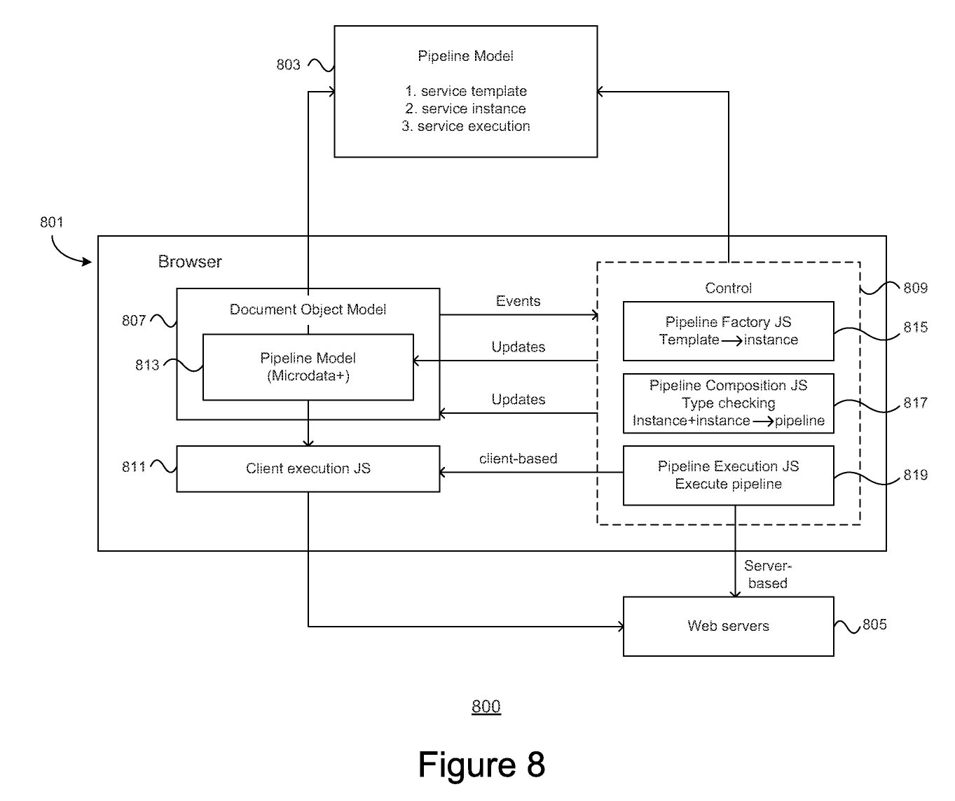

FIG. 8 depicts a system architecture 800 for generating and executing hyperlink pipelines formed from multi-service resources, in accordance with embodiments of the present invention. As depicted in FIG. 8, generating and executing hyperlink pipelines is performed with a pipeline model 801 that defines: 1) a plurality of service templates associated with a resource; 2) how service instances are associated with service templates; and 3) how a service can be executed based on the service template. The model itself may be embedded through a special markup language Microdata+ inside an HTML document retrieved from a web server 805, for example. The HTML document including the pipeline model may be accessed as a Document Object Model (DOM) object 807 through standard DOM API.

In one or more embodiments, the DOM object 807 may interact with JavaScript components responsible for constructing service instances from service template (815), combining service instances into hyperlink pipeline (817), and executing hyperlink pipelines (819). These components control the DOM and the pipeline model by updating them based on received events from the DOM object and invoking the custom JavaScript functions in the service templates.

In one or more embodiments, events (such as user interface actions) that activate the hyperlink pipeline construction from a service template are performed by a Control Module 809 in the web browser 801. The Control Module 809 contains a pipeline factory module 815 to construct a plurality of service instances from the service template in the pipeline model by executing one or more JavaScript functions.

In one or more embodiments, events (such as user interface actions) that activate the hyperlink pipeline construction from service instances are performed by a Control Module 809 in the web browser 801. The Control Module 809 contains a pipeline composition module 817 that combines multiple service instances to form hyperlink pipeline instances. The Pipeline Composition Module 817 performs a validation of the “type” of resources before combining them into a hyperlink pipeline. For example, a call pipeline that connects an accept-call service with a phone resource can be created because the accept-call service accepts a phone resource as a parameter, whereas a call pipeline that connects the accept-call service with another call resource will fail because it does not accept such a parameter. Finally, the hyperlink pipeline is executed by the Execution Module 819, which may invoke the JavaScript execution module 811 in the browser 801 for client-based implementations, or transmitted to a remote server 805 for execution in server-based implementations.

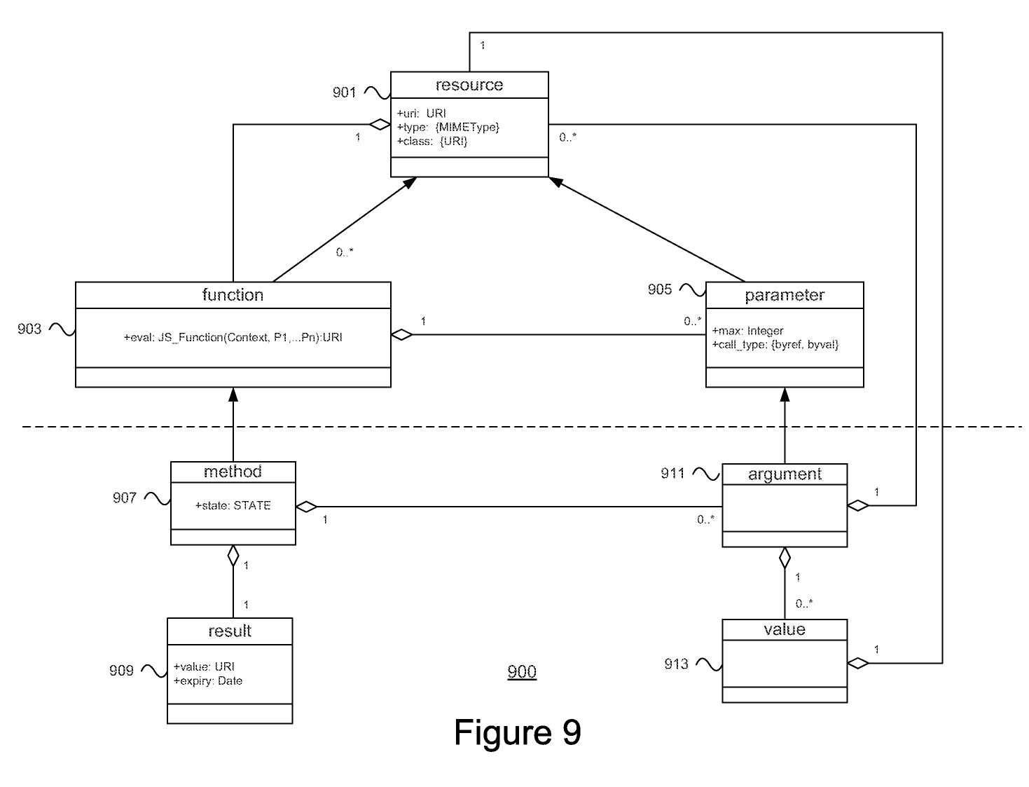

FIG. 9 depicts a UML class diagram 900 of resources in a multi-service pipeline system, in accordance with one or more embodiments of the present invention. In one or more embodiments, a resource can be associated with multiple service functions, and each service function can be associated with a custom JavaScript function and be instantiated by many service methods to form hyperlink pipelines that use the same service function. According to such a model, a resource 901 may contain a plurality of service functions 903 (service template), and each service function may contain one or more parameters 905. A plurality of service methods 907 (service instance) may be created from a service function, and a service method may contain a result 909 and one or more arguments 911 that are associated with both the corresponding parameters of the service function, and a value 913.

Relationships between the classes are also depicted in FIG. 9. For example, a triangular arrow head from one class to another indicates the former class is a sub-class of the latter (parent) class, and that the subclass inherits the attributes of the parent class. For example, a function class inherits a resource class and includes the attributes of the parent resource class. A diamond arrow head from one class to another indicates the target class includes an association (such as being a composition) of the source class. In one embodiment, a function class may include one or more parameters.

In one or more embodiments, the classes depicted in FIG. 9 above the dashed line (e.g., classes corresponding to resource 901, function 903 and parameter 905) specifies the service templates associated with a multi-service resource. As depicted in FIG. 9, resource class 901 includes attributes such as the URI (uniform resource identifier), type (as a MIMEType) and class (of URI). Function class 903 includes attributes such as evaluate custom JavaScript function. Parameter class 905 includes attributes including a max (number of parameters, as an integer, for example), and a call type (e.g., by reference or by value). If a parameter call type is by-ref, then the cached value of the parameter can be reused when evaluating the custom JavaScript function. If the call type is by-val, then the parameter will be evaluated each time the custom JavaScript function is evaluated.

In one or more embodiments, the classes depicted in FIG. 9 below the dashed line (e.g., classes corresponding to method 909, result 911, argument 913, and value 915) correspond to one or more service instances created by a user of the multi-service pipeline system from the service templates. As depicted in FIG. 9, method class 909 may include attributes such as state (e.g., the present state of the resource). Each method 911 may include a result 913 (defined by the provider of the service), which includes attributes for value (such as a resource) and expiration (when the result expires). Members of the argument class 913 may include attributes such as a value, or another resource, whereas members of the value class 915 may include a reference to another resource.

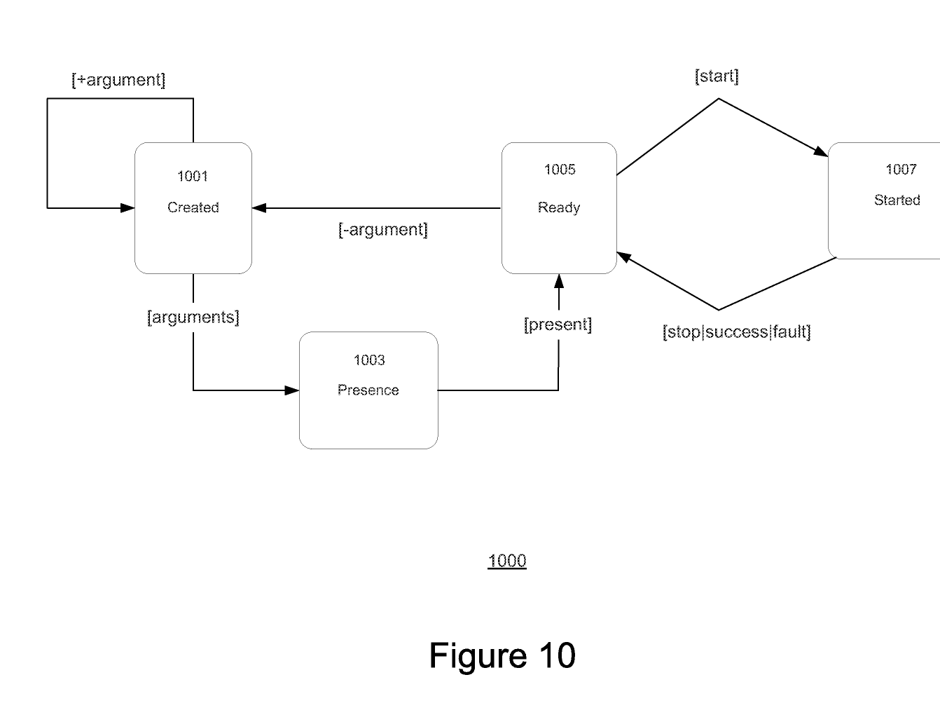

FIG. 10 depicts a state diagram 1000 of exemplary states for a service instance in a multi-service pipeline system, in accordance with embodiments of the present invention. As depicted in FIG. 10, a service instance in state diagram 1000 may correspond to one of 4 possible states, e.g., Created State 1001, Presence State 1003, Ready State 1005, and Started State 1007. In one or more embodiments, a service instance under a Created State 1001 indicates a pipeline for the service has been created. When a valid argument (e.g., resource hyperlink) is added to the service instance, the service instance can proceed to a Presence State 1003. In one or more embodiments, Presence State 1003 includes one or more presence sub-states that indicate the readiness of the service instance. For example, a service instance such as a web-based real-time call can enter a ready sub-state when all the arguments representing the calling parties become ready. In the alternative, if an event such as a length of time above a pre-determined duration has elapsed without further user action, the service may enter an idle sub-state that indicates the user's unattention. Yet another alternative include an inactive sub-state that indicates the user does not desire to be contacted via the service at this time.

When the service instance is in an active ready sub-state, the service instance may enter the Ready State 1005 and make and/or receive further operations (e.g., calls for the web real-time call service). When a call is started in the above example, the service instance may enter the Started State 1007 until such a time as the call is terminated (by user hang-up, system disconnection or failures). Once the call is terminated, the service instance returns to the Ready State 1005, and then returns to the Created State 1001 when an argument is removed from the service instance.

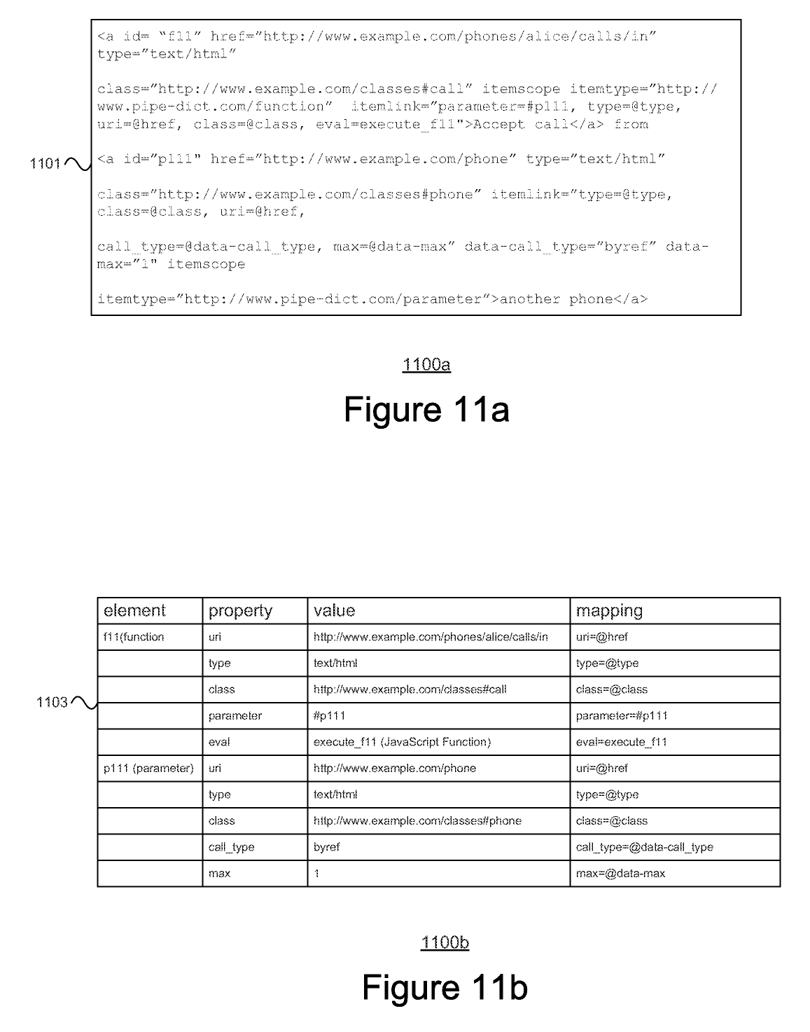

FIG. 11a depicts an example portion 1101 of an exemplary HTML document 1100a containing an “accept call” function f11 associated with a multi-service phone resource using a markup language, in accordance with embodiments of the present invention. As depicted in HTML document 1100a, “accept call” function has one parameter p111 for another phone resource. The service function and the parameter are annotated by Microdata+ tags “itemtype” and “itemlink,” respectively, according to the pipeline model as described in the present invention. In particular, the HTML element <a id=“f11”> represents an “accept call” service function, as indicated by the Microdata+ tag “itemtype.” The Microdata+ tag “itemlink” contains a key-value pair: “parameter=#p11,” that associates the service function f11 to its parameter p111 represented by HTML element <a id=“p111”>, which in turn contains Microdata+ tags that define the properties of this parameter.

FIG. 11b depicts a table 1100b that represents the data structure 1103 of the “accept call” function parsed from the specification in the exemplary HTML document 1101 depicted in FIG. 11a, in accordance with embodiments of the present invention. This data structure may be implemented by JavaScript and used by the Control Module during the hyperlink pipeline constructions.

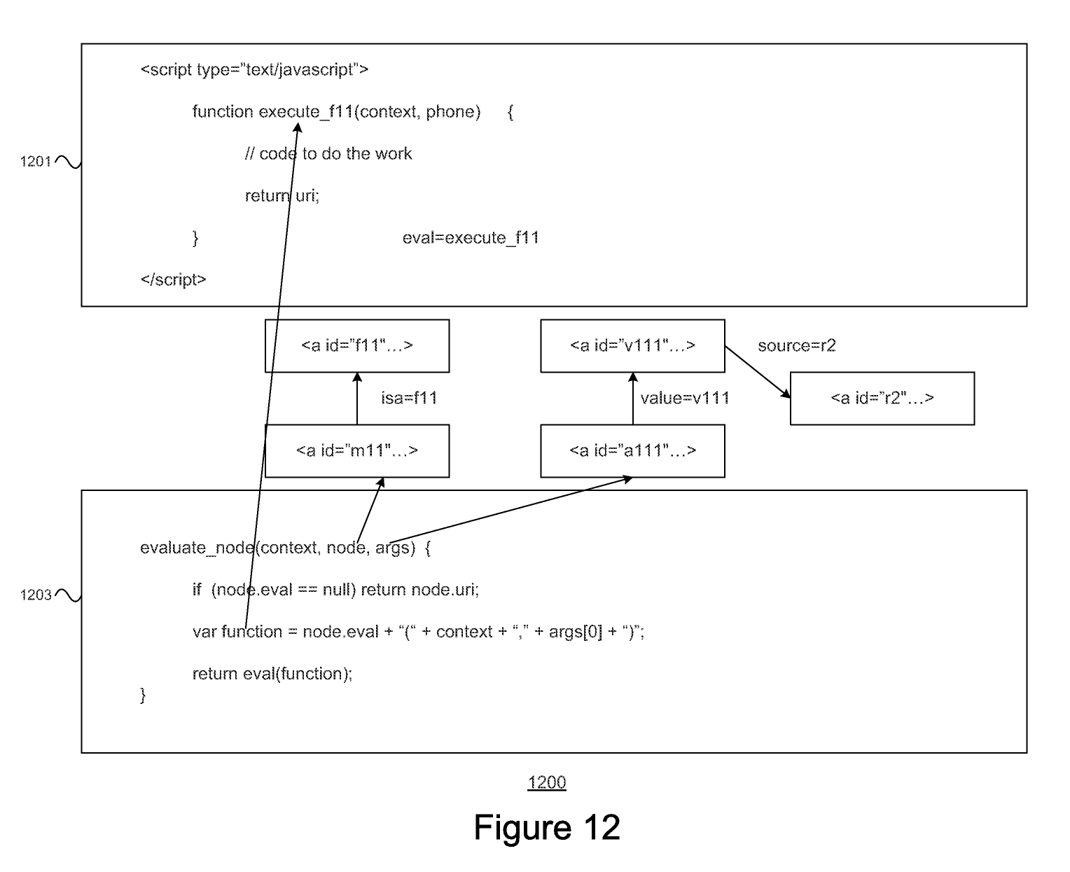

FIG. 12 depicts a portion 1200 of an exemplary programming pseudo-code which, when stored in a memory and executed by a processor, is operable to execute an exemplary process to evaluate custom JavaScript functions associated with a service function during the execution of a hyperlink pipeline. In an embodiment, a custom JavaScript function associated with a service function during the execution of a hyperlink pipeline can be evaluated by first locating the custom JavaScript function and corresponding arguments based on the parsed service method data structure, and then combining the located function and arguments for evaluation, in accordance with embodiments of the present invention.

As depicted in FIG. 12, a service instance is treated as a node in a tree and the node is executed by an evaluate_node function 1203 when the hyperlink pipeline is executed. In one or more embodiments, the evaluate_node function 1203 may take in one or more other parameters (e.g., context, node, args). As depicted in FIG. 12, the node parameter may reference a service method resource (e.g., “m11”), which references a service function resource (“f11”), with the args parameter referencing an argument resource (e.g., “a111”) that references a value resource (e.g., “v111”), which itself references another source resource (“r2”). In one or more embodiments, the evaluate node function may be called when a service function is executed (e.g., service function comprised in box 1201).

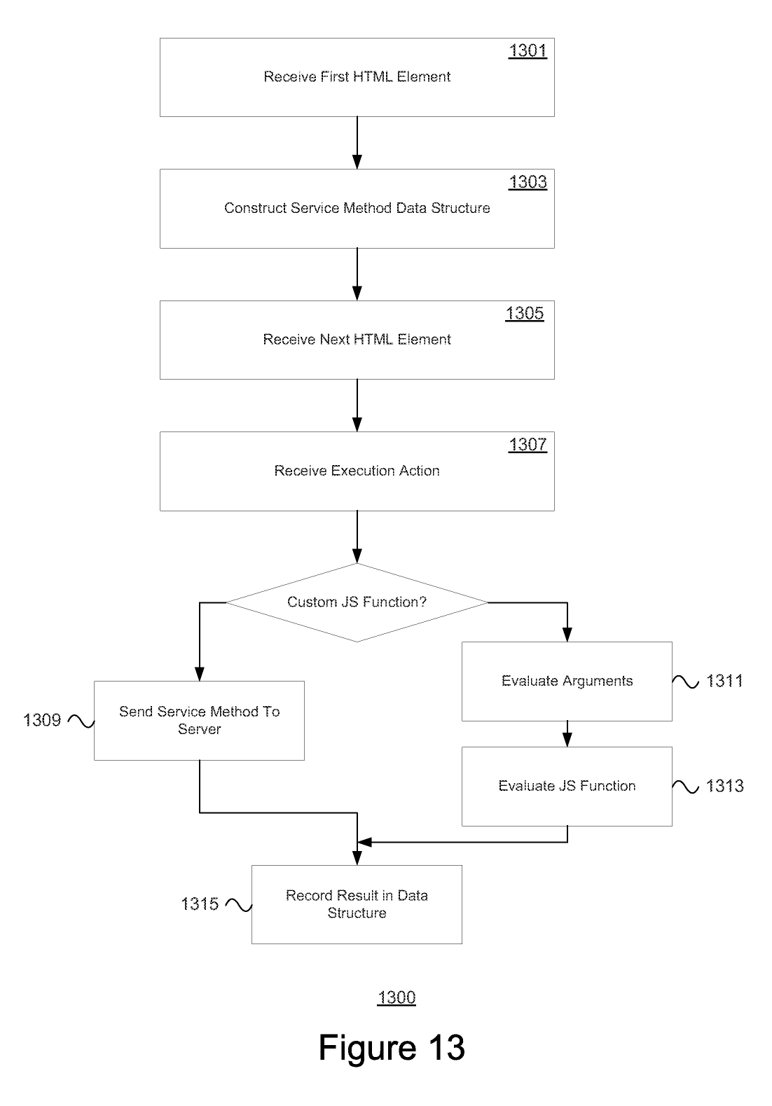

FIG. 13 is a flowchart 1300 of a method for constructing a hyperlink pipeline from a service function associated with a multi-service resource, in accordance with one embodiment. In one or more embodiments, the hyperlink pipeline may be constructed from one or more HTML links displayed on one or more web pages. Steps 1301-1315 describe exemplary steps comprising the process depicted in flowchart 1300 in accordance with the various embodiments herein described. In one embodiment, the flowchart 1300 is implemented as computer-executable instructions stored in a (non-transitory) computer-readable medium and performed by a computing device executing a web browser.

At step 1301, a service function receives—via user action—a hyperlink. In one of more embodiments, the hyperlink is received as a parameter of the service function. In one or more embodiments, the action may correspond to user-input received via a user input device on a graphical display of content presented in the web browser. In one or more embodiments, the service function is implemented by a processor executing a web browser in a client device. In one or more alternate embodiments, the service function is implemented in a server hosting web resources accessible to the client device. At step 1303, the service function instantiates a service method with an argument referencing the hyperlink and displays the service method graphically on a display device using the web browser. In one or more embodiments, the service function is implemented as an element of a UML class, and the service method is an instantiation of the service function class. At step 1305, the service method receives a second hyperlink (as a different argument) via a second user action. In one or more embodiments, the argument includes (stores) a reference to the hyperlink. In one or more embodiments, this step can be repeated for every other argument of the service method. As a service method may be the argument of another service method, a hyperlink pipeline constructed by this process may be represented by a tree of service methods (nodes).

At step 1307, the service method receives a third user action indicating an execution of the service method. In one embodiment, the third user action may consist of, for example, a hyperlink of the instantiated service method in the web browser. Subsequently, the service method is referenced to determine if the service method includes a JavaScript function. If the service method does not contain a custom JavaScript function, then the service method combines the hyperlinks in a pipeline and sends the combined hyperlinks to the server for remote execution (step 1309), before proceeding directly to step 1315. If the service method contains a custom JavaScript function, the method will evaluate the arguments (step 1311) to get the values of the arguments, before the service function evaluates the custom JavaScript function with the received values (step 1313). Finally, the service function will return and display the evaluated result on the HTML page (step 1315).

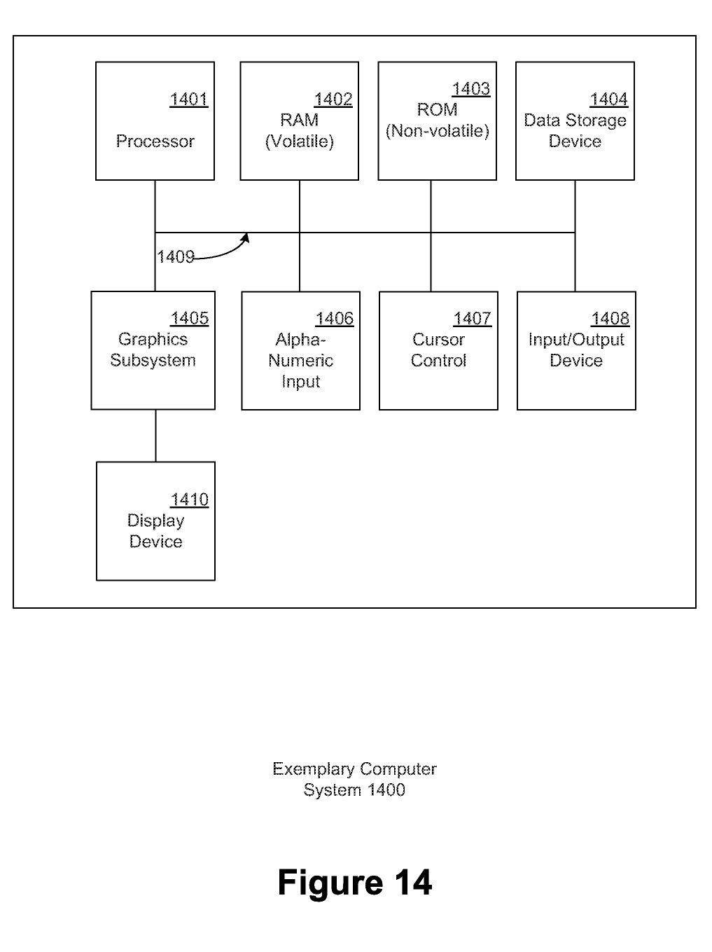

FIG. 14 depicts an exemplary computing environment 1400 upon which embodiments of the present invention may be implemented. In one or more embodiments, either (or both) the client computing device executing the web browser or the server computing device hosting the online resources described above may be implemented as a variation or configuration of computing environment 1400. In its most basic configuration, computing environment 1400 includes at least one processing unit 1401 and memory, and an address/data bus 1409 (or other interface) for communicating information. Depending on the exact configuration and type of computing environment, memory may be volatile (such as RAM 1402), non-volatile (such as ROM 1403, flash memory, etc.) or some combination of the two.

Computing environment 1400 may also comprise an optional graphics subsystem 1405 for presenting information to the computer user, e.g., by displaying information on an attached display device 1410, connected by a video cable 1411. According to embodiments of the present claimed invention, the graphics subsystem 1405 may be coupled directly to the display device 1410 through the video cable 1411. In alternate embodiments, display device 1410 may be integrated into the computing environment (e.g., a laptop or netbook display panel) and will not require a video cable 1411. The web browser described above with respect to various embodiments may be generated in the graphics subsystem 1405, for example, and graphically presented to the computer user through display device 1410.

Additionally, computing environment 1400 may also have additional features/functionality. For example, computing environment 1400 may also include additional storage (removable and/or non-removable) including, but not limited to, magnetic or optical disks or tape. Such additional storage is illustrated in FIG. 14 by data storage device 1407. Computer storage media includes volatile and nonvolatile, removable and non-removable media implemented in any method or technology for storage of information such as computer readable instructions, data structures, program modules or other data. RAM 1402, ROM 1403, and data storage device 1407 are all examples of computer storage media.

Computing environment 1400 also comprises an optional alphanumeric input device 1407, an optional cursor control or directing device 1407, and one or more signal communication interfaces (input/output devices, e.g., a network interface card) 1409. Optional alphanumeric input device 1407 can communicate information and command selections to central processor 1401. Optional cursor control or directing device 1407 is coupled to bus 1409 for communicating user input information and command selections to central processor 1401. Signal communication interface (input/output device) 1409, also coupled to bus 1409, can be a serial port. Communication interface 1409 may also include wireless communication mechanisms. Using communication interface 1409, computer system 1400 can be communicatively coupled to other computer systems over a communication network such as the Internet or an intranet (e.g., a local area network), or can receive data (e.g., a digital television signal). In one example, hyperlinks appearing in a rendered web page in the web browser displayed in display device 1410 may be actuated by the user via alphanumeric input device 1407 and/or cursor control or directing device 1407 to create a new service pipeline and/or instance of an existing service. The web browser may then be updated with the graphical representation of the ensuing service instance.

Although the subject matter has been described in language specific to structural features and/or processological acts, it is to be understood that the subject matter defined in the appended claims is not necessarily limited to the specific features or acts described above. Rather, the specific features and acts described above are disclosed as example forms of implementing the claims.

What is claimed is:

1. A method performed in a computing system for constructing a hyperlink pipeline, the method comprising:
displaying a webpage in a web browser executed by a processor in a client computing device;
receiving a first hyperlink corresponding to a service function;
in response to receiving the first hyperlink, generating a service method in the processor based on the service function;
receiving a second hyperlink corresponding to the service method;
receiving a signal indicative of executing the service method in the processor of the client computing device;
determining, in the processor, when the service method comprises a custom JavaScript function;
sending a combination of the first hyperlink and the second hyperlink to a remote server for execution when the service method does not comprise a custom JavaScript function;
when the service method is determined to comprise a custom JavaScript function,
determining a value of an argument corresponding to the custom JavaScript; and
evaluating the custom JavaScript function based on the value.

2. The method of claim 1, wherein sending the combination of the first hyperlink and the second hyperlink to the remote service comprises:
receiving an execution of the first and second hyperlinks from the remote server; and
displaying the execution in web browser.

3. The method of claim 1, wherein evaluating the custom JavaScript function comprises:
validating the value of the argument in the processor;
executing the JavaScript function in the processor; and
displaying an execution of the JavaScript function in the web browser.

4. The method of claim 3, wherein executing the JavaScript function comprises executing the JavaScript function with the processor through an application programming interface (API) of the web browser.

5. The method of claim 1, wherein receiving the first hyperlink comprises determining a first signal via a user input device communicatively coupled to the client computing device, the first signal being indicative of a selection of the first hyperlink in the webpage.

6. The method of claim 4, wherein receiving the second hyperlink comprises determining a second signal via the user input device, the second signal being indicative of a selection of the second hyperlink in the webpage.

7. The method of claim 1, wherein the first hyperlink comprises a parameter of the service function.

8. The method of claim 1, wherein the service method comprises an instance of the service function.

9. The method of claim 8, wherein generating the service method comprises
generating the service method as an instance of the service function using the first hyperlink as a first argument; and
displaying a graphical representation of the service method in the web browser.

10. The method of claim 9, wherein receiving the second hyperlink comprises receiving the second hyperlink as a second argument of the service method.

11. The method according to claim 1, wherein the service function is an element of a Unified Markup Language (UML) class.

12. The method of claim 1, wherein the service function comprises a document object model (DOM) element.

13. The method of claim 1, wherein each of the first hyperlink and the second hyperlink is implemented using HTML programming code.

14. The method of claim 13, wherein a plurality of properties of the first hyperlink and the second hyperlink are implemented as a plurality of annotations embedded in the HTML programming code comprising the first and second hyperlinks.

15. The method of claim 14, wherein the plurality of annotations comprise portions of Microdata+ programming language.

16. The method of claim 1, wherein at least one of the first web resource and the second web resource have a corresponding state.

17. The method of claim 17, wherein sending a combination of the first hyperlink and the second hyperlink to a remote server for execution when the service method does not comprise a custom JavaScript function comprises at least one of:
executing a call-by-reference function; and
executing a call-by-value function.

18. A client computing device comprising:
a network device for communicatively coupling the client computing device with a remote server;
a memory device for storing programmed instructions;
a user input device configured to receive a signal; and
a processor configured to execute a web browser from the programmed instructions, the web browser being configured to receive, via the user input device, a selection of a hyperlinks accessible through a web page communicated through the network device,
wherein, the processor is further configured to generate an instance of a service function based on the selection of the hyperlinks, to determine if the instance of the service function comprises a custom JavaScript function, and to send a combination of the first and second hyperlinks to the remote server for execution when the service function does not comprise a custom JavaScript function.

19. The client computing device of claim 18, wherein the processor is further configured to determine a value of an argument corresponding to a custom JavaScript function, and to evaluate the custom JavaScript function based on the value when the instance of the service function is determined to comprise a custom JavaScript function.

20. A server computing device comprising:
a network device for communicatively coupling the server computing device with a remote client device;
a memory device for storing programmed instructions corresponding to a plurality of network resources;
a signal communication interface configured to receive a signal from the remote client device, the signal corresponding to a selection of hyperlinks; and
a processor configured to generate an instance of a service function based on the selection of the hyperlinks, to determine if the instance of the service function comprises a custom JavaScript function, and to construct a new executable hyperlink pipeline comprising a combination of the first and second hyperlinks when the service function does not comprise a custom JavaScript function,
